(19) United States
(12) Patent Application Publication
(10) Pub. No.: US 2022/0265090 A1
(43) Pub. Date: Aug. 25, 2022

(54) HERB GRINDER

(71) Applicant: Edward Ian Hall, Derby (GB)

(72) Inventor: Edward Ian Hall, Derby (GB)

(73) Assignee: FIBONACCI INNOVATIONS LTD, Derby (GB)

(21) Appl. No.: 17/182,260

(22) Filed: Feb. 23, 2021

(51) Int. Cl. A47J 42/42; A47J 42/24; A47J 42/28; A47J 42/30

(52) U.S. Cl. CPC A47J 42/42; A47J 42/24; A47J 42/28; A47J 42/30

(57) ABSTRACT

The present invention relates to a herb grinder. More particularly it is a compact-pocket size 3 piece or 4 piece grinder chassis including herb grinding compartment, spinning herb chamber floor compartment, nectar/crystal storage area and a rectangular side storage tray which is magnetically inserted into grinder chassis. The herb grinding compartment floor includes static cutting teeth, machined hole opening and central axle socket which runs perpendicular vertically down the center. This grinder further includes a lid and a hand crank embedded in it which when moved, moves all the connected components. The first compartment pulverizes the herbs into small chunks inside the herb grinding compartment, which then flows downward through the hole opening leading the herb to enter spinning chamber floor which then directs the herbs to longitudinal side storage tray.

### FIELD OF INVENTION

The present invention relates to herb grinder and more specifically a compact non circular three or four piece herb grinder which has a central axel mechanism and a side storage to collect and store grinded herb.

### BACKGROUND OF THE INVENTION

Herb grinders are well known and are in use for different purposes, and at a different configuration. Grinders come in all sorts of different sizes, shapes and weights. These include regular 2 piece grinders, 3 piece grinders and 4 piece grinder. The problem with current-4 piece herb grinder designs is that they comprise of a. circular design which consists of vertically stack compartments; grinding compartment, processed herb storage, nectar/crystal storage area. When these grinders e stacked vertically, the biggest volume area is usually the processed herb storage which increases the thickness of the grinder. Moreover the hand crank above the grinder lid also increases the thickness of the grinder.

These vertically stacked arrangement can only be made compact by reducing the volume of the processed herb storage area or removing the nectar/crystal storage area or removing either these storage area or reducing the diameter of the grinder. These reductions will eventually reduce the volume of grinding compartment and the functionality.

There are many herb grinders which uses 2 piece, 3 piece or 4 pieces grinders and storing mechanism. For example, US20200029738A1 describes a herb and spices grinder which has a plurality of sections that are removably connected together. A hole is formed at the outer periphery of each of the plurality of sections. The plurality of sections can be rotated relative to one another so that the holes align to form a passageway. The bolt of a lock can be inserted through the passageway so as to prevent the sections from rotating relative to one another and to prevent the sections from being separated from one another. As a result, undesired access to the contents of such herb and spice grinder is effectively prevented. Preferably, rotation of a top section relative to an intermediate section causes a grinding of the herb or spice. The ground material passes through openings in the intermediate section to be stored in a receptacle formed in a bottom section.

Moreover, U.S. Pat. No. 9,392,908 talks about a shredder or grinder for dried material such as herbs of dried leaves which is a cylindrical container formed of a top element and a base element forming a chamber, the top element and the base element each having a series of concentrically arranged teeth on a base plate, wherein the teeth that slidably engage one another in a slicing motion to form grinding surfaces against one another, wherein the teeth are serrated to efficiently grind the dried materials in the chamber when the teeth engage one another and are counter rotated relative to one another, In one embodiment the chamber discharges the ground contents through orifices in the base element, where the size is regulated by a screen, and in another embodiment, the ground contents remain in the chat be until the grinding head is removed.

Moreover, there are also patents which uses grinding sheet for grinding herb or similar plant or food related substances to a fine mulch or small particulate form suitable for different uses. For example, U.S. Pat. No. 8,672,249 describes a herb grinder which includes a metal sheet having a first surface and an opposite second surface. the sheet being configured to include, on at least one of the surfaces, a plurality of grooves extending parallel with one another and spaced apart from one another, wherein the grooves and at least one of the surfaces, a plurality of grooves extending parallel with one another and spaced apart from one another, Wherein the grooves and said at least one of the surfaces define a square wave shape having flat valleys and flat peaks, wherein the flat valleys are roughened by a process of photochemical etching. A plurality of holes of a first type, extending from a peak to the bottom surface of the metal sheet, and a plurality of holes of a second type extending from a valley to the bottom surface of the metal sheet. The metal sheet may include an opening adjacent an edge of the sheet, and a flexible link may be fastened to the metal sheet through the opening.

The inventions mentioned above address different grinders and their functionality, storing space and plurality of holes for the desired grinding, but none of them mention about a magnetically attached longitudinal storing tray which can be easily attached or detached with the grinder making the grinder compact, portable and pocket size. Thus, there is a need for a 4 piece herb grinder where the processed. herb storage area is arranged sideways instead of vertically. Moreover, there is also a need for an invention which will utilize the internal mechanism to replace bulky and thick processed herb storage area into the side storage area, resulting in an overall thickness reduction without any loss of functionality.

### OBJECTIVE AND SUMMARY OF THE INVENTION

The present disclosure overcomes one or more shortcomings of the prior art and provide additional advantages discussed throughout the present disclosure. Additional features and advantages are realized through the techniques of the present disclosure. Other embodiments and aspects of the disclosure are described in detail herein and are considered a part of the claimed disclosure.

The principle object of present invention is to overcome the aforementioned drawbacks and limitation by providing a compact and portable non circular 3 piece/4 piece grinder which will move the volume of the herb storage from a stacked arrangement. into a longitudinal storage solution via a mechanical mechanism. Another objective of the invention is to provide a grinder that can easily switch between a 4 piece grinder functionality and a 3 piece grinder functionality at the user's discretion and without any changes in the overall thickness.

Yet another objective of the invention is to provide a manual hand crank which is engineered into the grinder lid at 90 degrees, adding zero increase to the grinder's thickness unlike previous hand crank designs.

Yet another objective of the invention is to provide a side storage tray that can be magnetically removed and inserted from the grinder chassis with a separate magnetic storage lid. This storage lid can be connected to both the storage tray base and the opening of the side storage tray.

According to one embodiment, the central axel mechanism through usermanual input connects the torque that spins the grinder teeth compartment with the second compartment's rotating floor which are stacked above one another.

According to another embodiment, the first grinding compartment's teeth rotates to pulverize larger herbs into smaller processed compartments, which are filtered downwards through precise hole sizes into the second area. This second compartment area has rotating herb chamber floor that can be either (interchangeable) a nectar/crystal wire filter (4 piece grinder) or a solid flat plate with no filtering Option (3 piece grinder) with no additional effect upon the overall thickness.

According to one more embodiment, the second compartment mechanically rotating floor aids in the motion that directs processed herbs centrifugally outward from the centre, herbs on the outer circumference then hit the static directional arm whose physical presence directs the processed herbs sideways and longitudinally into the side storage medium.

### BRIEF DESCRIPTION OF DRAWINGS

The forgoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure reference by a numeral in a drawing is applicable to the description of that method step or structure shown by that same numeral in any subsequent drawing herein.

FIG. 1 illustrates view of one exemplary embodiment of the herb grinder of present invention.

FIG. 2 illustrates one exemplary view of a 4 piece herb grinder of present invention.

FIG. 3 illustrates view of a 4 piece herb grinder with a nectar filter configured over a nectar collector.

FIG. 4 illustrates view of a 3 piece herb grinder embodiment of present invention.

FIG. 5A shows view of a main body or chassis of the herb grinder of present invention.

FIG. 5B shows bottom view of the main chassis of the herb grinder of FIG. 4A.

FIG. 6A shows top view of the lid of the herb grinder of present invention.

FIG. 6B shows view of the lid with an upright hand crank.

FIG. 6C shows a bottom view of the lid of the herb grinder of present invention.

FIG. 7 shows a cut sectional view of the herb grinder of present invention.

### DETAILED DESCRIPTION OF THE INVENTION

The present invention overcomes the aforesaid drawbacks of the above, and other objects, features and advantages of the present invention will now be described in greater detail. Also, the following description includes various specific details and are to be regarded as mere exemplary. Accordingly, those of ordinary skill in the art will recognize that: without departing from the scope and spirit of the present disclosure and its various embodiments there may be any number of changes and modifications described herein.

The herb grinder of present invention is provided which is more compact compared to other circularly stacked herb grinders as the present herb grinder includes a herb storage compartment beside the herb grinding compartment instead of stacked up on each other this decreasing vertical height of the herb grinder hence taking it practical for conveying it within a pockets. According to one embodiment, the herb grinder of present invention is made in two different embodiments, one in three piece and another one in four piece (with one extra piece).

According to one embodiment, the herb grinder of present invention is made of a main body or chassis having a compartment which turns into a herb grinding compartment when a grinding lid of the herb grinder is configured on it. According to one embodiment, the main body in herb grinding compartment of present invention includes plurality of teeth protruding in upward direction from the bottom surface and also plurality of holes made within the bottom surface for the grinded herbs to enter into the temporary collection compartment through holes.

According to one embodiment, the grinding lid further includes plurality of teeth protruding from the bottom surface of the lid that sets within the grinding compartment when the lid is configured over the main body of the herb grinder. According to one embodiment, the lid of the herb grinder is rotatable causing the teeth of the lid to rotate within the grinding compartment while keeping the teeth of the main body stationary. This relative movement of teeth of lid with the teeth of main body within the grinding compartment pulverizes larger herbs into a smaller herbs which gets filtered downward into a temporary collection compartment through a plurality of holes of the bottom surface of herb grinder.

The temporary collection chamber of present herb grinder includes a rotating herb chamber floor that is coupled with the grinding lid through a central axel mechanism that spins the rotating herb chamber floor in the temporary collection chamber with the rotation of the lid directing the grinded herb entering into the collection chamber centrifugally outward from the center towards the outer circumference. According to one embodiment, the main body includes a static directional arm within the temporary collection chamber that directs the processed herb sideway where an aperture within the main body opening into a storage unit collects and stores the processed herb.

According to one embodiment, the rotating herb chamber floor is interchangeable between a nectar/crystal wire filter over a solid bottom plate (4 piece) and direct solid bottom plate without a filter (3 piece) without any overall effect on thickness of the herb grinder.

According to one embodiment, the nectar/crystal filter at the rotating herb chamber floor filters the nectars or crystals present within the processed herb before the processed herb may enter into a storage. According to one embodiment, the storage unit magnetically attaches with the main body longitudinally such that the opening of the storage unit aligns with the aperture beside static directional arm of the temporary collection chamber of the main body so that the processed herb directed outwardly due to the centrifugal movement may easily enter within the storage unit.

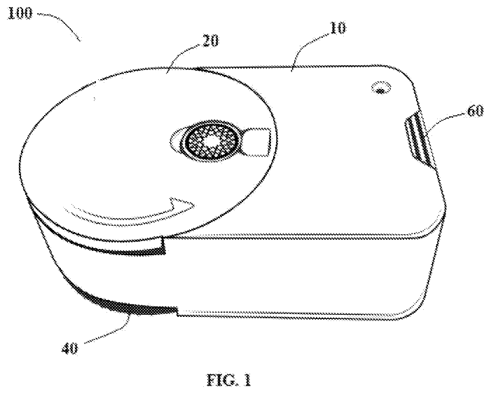

Referring to FIG. 1 now, which shows one exemplary embodiment of a herb grinder 100 of present invention having a storage unit attached longitudinally with the grinding compartment to collect and store the processed herbs. According to present embodiment, the herb grinder is comprising of a main body or chassis 10 of the herb grinder 100 with a grinding lid rotatively mounted over the grinding compartment of the main body 10 such that the rotating movement of the teeth of the grinding lid relative to the teeth of the stationary permanent teeth of the main body within the grinding compartment may pulverize the herb into small pieces, when the grinding lid is manually rotated by the user.

According to present embodiment, the herb grinder main body includes a chamber that becomes a grinding compartment, when the grinding lid is attached over it. Further, it includes a temporary collection chamber for processed/grinded herbs beneath the grinding compartment, stacked, to collect the processed herb, which is formed by connecting a solid bottom plate 40 beneath the grinding compartment of the herb grinder 100 aligned to it using a central axel. According to one embodiment, a nectar filter may be placed between in temporary collection chamber making it a 4 piece herb grinder 100 to further filter the nectars or crystals present within the processed herbs.

According to one embodiment, the main body 10 of the herb grinder 100 includes a casing for the storage unit longitudinal to the grinding and temporary herb collection chamber, where the storage unit/side storage tray can be removably inserted during the grinding process to collect the processed herb. Further, a side storage lid 60 is provided to magnetically couple at the outer side of the storage tray during grinding process.

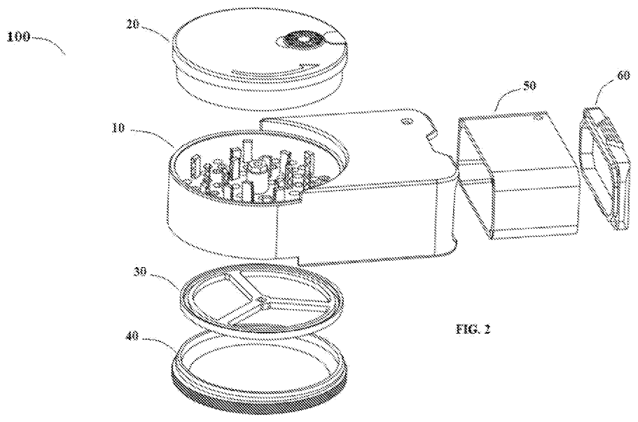

FIG. 2 shows an exploded view of an herb grinder 100 (4 piece embodiment). According to the present embodiment, the herb grinder 100 is comprising of a chassis or a main body 10 having a grinding compartment and a temporary collection chamber stacked on each other and a casing beside both the chamber longitudinal. to them to encase the side the side storage tray 50 during grinding. The main body 10 includes an opening within the temporary collection chamber that opens within the side storage tray 50, when the tray is magnetically installed within the casing of the herb grinder 100.

According to present embodiment, the grinding compartment further includes plurality of stationary teeth and holes and a central aperture with a plurality of an axel bearings for configuration of a central axel that connects the top grinding lid 20 and bottom rotating floor 30 over which a wire mesh nectar filter (not shown) gets placed. The plurality of an axel bearings are configured to allow free rotation of upper grinding lid 20 and the bottom rotating floor 30 relative to the stationary main body 10 through a central axel.

According to one embodiment, when the grinding lid 20 is configured over the main body 10 using the central axel, it forms a grinding compartment with an stationary teeth of the main body 10 and a rotating teeth of the grinder lid 20 that are formed such that while rotating within the grinder compartment, it may pulverize with the herb placed within the grinder compartment and avoid the accident between the teeth of the grinding lid 20 and the teeth of the main body 10. Further, according to present embodiment, the grinding lid 20 includes a hand crank to allow user to manually hold the hand crank and rotate the grinding lid 20.

A configuration of the rotating bottom floor 30 at the bottom end of the central axel beneath the grinding compartment creates a temporary collection chamber for the grinded herbs. According to one embodiment, a nectar filter may be placed over the rotating floor 30 to filter out the nectars or crystals present within the processed herb which gets collected within the nectar collector plate 40 configured or stacked beneath the rotating floor.

Longitudinal to both the grinding compartment and the temporary collection chamber, the main body 10 includes a casing for placement or configuration of a side storage tray 50. According to present embodiment, the casing completely encases the side storage tray 50. According to one embodiment, while encased within the casing of the main body 10, the side storage tray 50 magnetically connects with the main body 10 that allows user to pull out the side storage tray 50 when needed.

According to present embodiment, the main body 10 includes an aperture within the temporary collection chamber at casing side such that the aperture may align with the opening of the side storage tray 50 when the tray 50 is configured within the casing of the main body 10 so that the processed herb may enter within the side storage tray 50 from the temporary collection chamber of the herb grinder 100. According to present embodiment, the herb grinder 100 includes a side storage lid 60 magnetically attachable at the opposite opening of the storage tray 50.

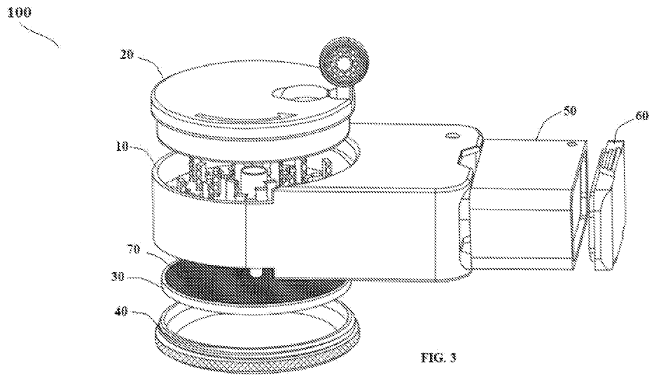

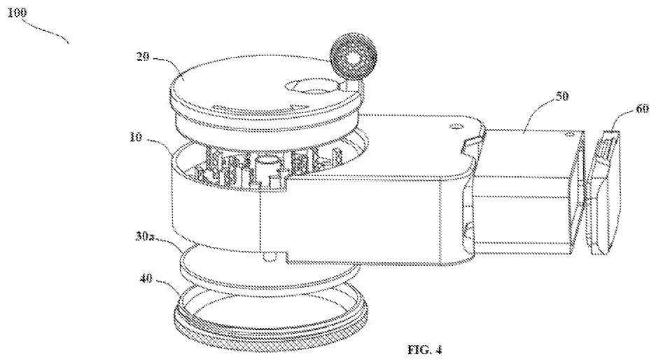

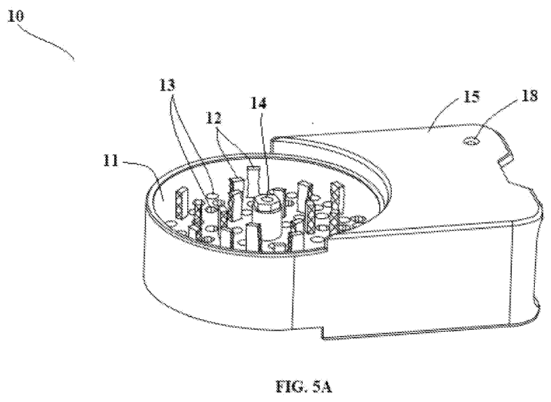

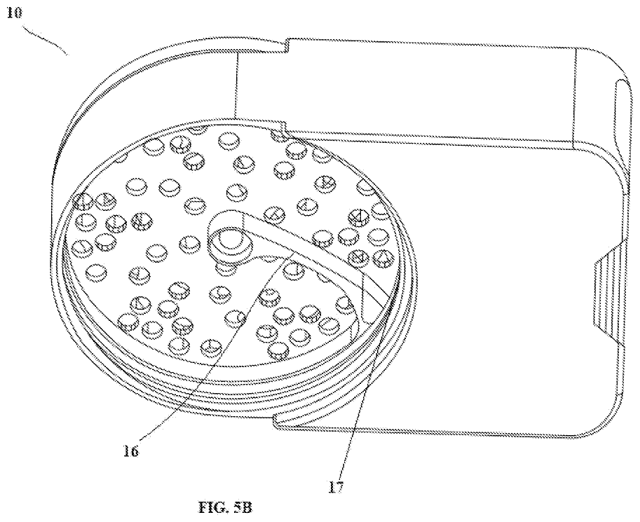

FIG. 3 shows a view of a herb grinder 100 of FIG. 2 with a nectar filter 70 placed over the rotating bottom floor 30 and a hand crank of the grinding lid 20 in upright position. According to present embodiment, a nectar/crystal filter 70 is made of a wire mesh that is capable to sit over the rotating bottom floor 30 to filter out the small unnecessary elements such as crystals from the processed/grinded herb. According to one embodiment, the herb grinder 100 includes a hand crank sits within the cavity over the upper surface of the grinding lid 20, aligning the level of the upper surface of the lid 20 when in rest position. The hand crank is capable of being removed from the cavity to stand in upright position so that the user may easily hold it using the fingers to rotate the lid 20 using it for grinding.

FIG. 4 shows one another embodiment of present herb grinder 100 made in a three piece without the nectar filter. According to present embodiment, the herb grinder 100 includes a solid flat plate 30a connected at the bottom end of the central axel beneath the grinding compartment instead of wire mesh nectar filter 70 that directs the processed herbs into the side storage tray without filtering the nectars or crystals.

FIG. 5A shows view of a main body or a chassis 10 of the herb grinder 100. According to present embodiment, the main body 10 of the herb grinder 100 includes a compartment for herb grinding 11 which completes when the opening is enclosed by the lid. According to present embodiment, the grinding compartment includes a bottom surface having plurality of fixed sharp edged teeth 12 protruding upright from the bottom surface around the circumference of the bottom surface. A plurality of fixed sized holes 13 made within the bottom surface for the grinded surface to filter out into the bottom temporary collecting compartment.

According to one embodiment, a central aperture is provided with plurality of axel bearings (not shown) for rotatable mounting of the central axel 14. According to one embodiment, the top of the central axel couples with the grinding lid while the bottom end of the central axel passing out of the bottom surface of the grinding compartment 11 couples with the bottom rotating floor 30 and the nectar filter, wherein the central axel rotates the bottom rotating floor 30 with the rotation of the upper grinding lid 10 while keeping the bottom surface of the grinding compartment 11 stationary.

The main body 10 of present herb grinder 100 further includes a side case 15 longitudinal to the grinding compartment 11 to encase the side storage tray beside the grinding 11 and temporary collection chambers of the main body 10. According to present embodiment, an additional aperture 18 is provided near the corner of the side case 15 as a sign for proper placement of the side storage tray.

FIG. 5B shows a bottom view of the main body 10 of the herb grinder 100 of FIG. 5A. According to present embodiment, the main body 10 at the bottom includes a static directional arm 16 that directs the processed herbs into the side storage box through an aperture 17. The rotation of the rotating bottom surface create a centrifugally outward force over the processed herb within the temporary collecting chamber, while the static directional arm 16 which is fixed with the main body within the temporary collection chamber directs the processed herb towards the aperture 17 from where the processed herb enters into the side storage tray 50.

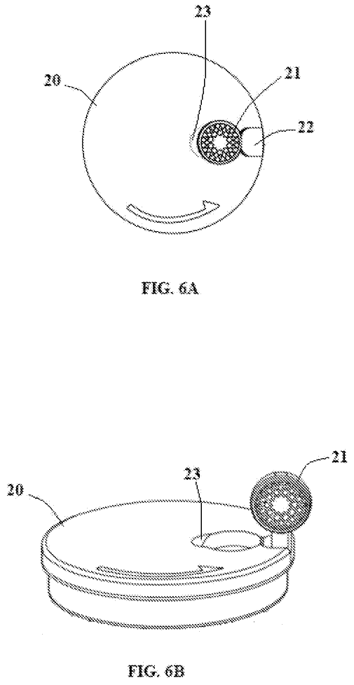

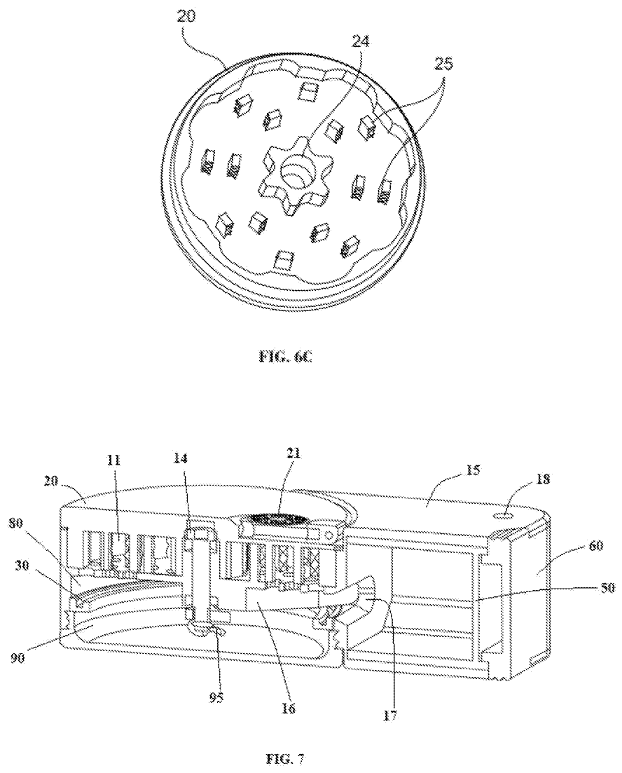

FIG. 6A and FIG. 6B shows a view of a top grinding lid 20 of the herb grinder 100 with a hand crank 21 in rest a ad upright position, respectively. FIG. 6A shows a hand crank 21 in rest position in cavity over such the hand crank 21 aligns with the level of the top surface of the lid 20. According to one embodiment, a hand crank 21 is connected with the lid 20 using a joint mechanism that allows hand crank 21 to get pulled in upward direction while being connected with the lid 20 as shown in FIG. 6B. A finger indentation 23 is provided near the cavity in which the hand crank 21 rests to allow user to grip the hand crank 21 and pull upright so that the user may hold the hand crank to rotate the grinding lid 20.

FIG. 6C shows a bottom view of the grinding lid 20 of present invention. According to present embodiment, the bottom surface of the lid 20 includes a plurality of edged teeth configured around the circumference and a socket 24 at the center to place the top end of the central axel which gets placed at the center of the grinding compartment 11 of the main body 10.

According to present embodiment, the central socket 24 of the grinding lid aligns with the central aperture of the grinding compartment where the central axel 14 is mounted to configure the grinding lid 20 over the top end of the central axel 14 from the central socket 24 of the grinding lid 20. The central axel 14, according to present embodiment, is configured within the central aperture of the grinding compartment 11 through a plurality of axel bearings (not shown) that allows the central axel to rotate within the central aperture of the grinding compartment 11 while keeping the main body 10 stationary. The central axel 14 behaves as a pivot for the rotation of the grinding lid 20 relative to the main body 10.

Further, the bottom end of the central axel 14 extends down the grinding compartment 11 where the rotating bottom plate 30 is locked using the R-clip (not shown). The grinding lid 20, the bottom surface of the grinding compartment 11 and the rotating bottom plate30 is concentrically stacked above each other, where the vertically mounted central axel 14 is configured to behave as a pivot to spin the grinding lid 20 which in turn further rotates the rotating bottom plate 30 simultaneously that creates outward direction centrifugal force over the grinded herb to dispense out the grinded herb into the side storage tray 50 through an aperture 17.

While, FIG. 7 shows a cut sectional view of present herb grinder 100 showing all the components fixed together for form a present herb grinder 100. According to present embodiment, the figure shows placement of each component in respect of other according to their functionality to provide final output of present invention. According to present embodiment, the lid 20 is configured over the compartment of the main body 10 to make it a grinding compartment 11 using the central axel 14 by placing a top of the central axel 14 within the central cavity at the bottom surface of the grinding lid 20. The central axel passes through the bottom surface of the grinding compartment 11 where the main body further includes a plurality of axel bearings (not shown) that allows rotation of the central axel with rotation of top grinding lid 20 while keeping the each part of the main body 10 stationary.

According to present embodiment, a rotating bottom floor 30 is configured at some space beneath the bottom surface of the grinding compartment such that the central axel passes from the center of the rotating bottom floor 30 where it locks the bottom floor 30 using a R-clip 95, whereby the rotation of the central axel further rotates the bottom floor 30. A placement of the nectar filter (not shown) over the bottom floor 30 creates a temporary collection chamber for the processed or grinded herb, wherein the rotation of the bottom floor 30 pushes the processed herb in outward direction while the static directional arm 16 within the temporary collection chamber directs the processed herb into the aperture 17 through which it enters into the magnetically attached side storage tray 50.

According to one embodiment, placement of the nectar collector disc beneath the nectar filter creates a nectar collector chamber 90 to collect the nectars or crystals being filtered out of the mesh nectar filter.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A herb grinder with a longitudinal side storage is comprising of:
a main body having a grinding compartment, a temporary collection chamber, and a side casing longitudinal to the herb grinding compartment and the temporary collection chamber;
a grinding lid configured over the grinding compartment of the main body;
a bottom rotating floor with a wire mesh nectar filter stacked below the grinding compartment to form a temporary collection chamber;
a nectar collection plate mounted beneath the bottom rotating floor to collect a nectars or crystals; and
a side storage tray capable of being inserted into the longitudinal side casing of the main body to collect a processed of grinded herb and store.

2. The herb grinder of claim 1, wherein the grinding compartment of the main body includes a plurality of sharp edged teeth protruding upright from a bottom surface of the grinding compartment.

3. The herb grinder of claim 1, wherein the bottom surface of the grinding compartment further includes a plurality of holes or apertures of specific size to filter out the grinded herb from the grinding compartment into the temporary collection chamber.

4. The herb grinder of claim 1, wherein the grinding compartment further includes a central aperture with a plurality of axel bearings to configure the central axel within the aperture.

5. The herb grinder of claim 1, wherein the plurality of axel bearings allows rotation of the central axel while keeping the main body or other elements of the grinding compartment stationary. cm 6. The herb grinder of claim 1, wherein the grinding lid connects with a top end of the central axel to get configured over the grinding compartment of the main body.

7. The herb grinder of claim 1, wherein the rotating bottom floor connects at a bottom end of the central axel which is passing out of the bottom surface of the grinding compartment.

8. The herb grinder of claim 1, wherein the manual rotation of the grinding lid by the user further rotates the rotating bottom floor while the plurality of axel bearings keeps the main body stationary.

9. The herb grinder of claim 1, wherein the grinding lid further includes a plurality of a sharp edge teeth protruding out of a bottom surface of the grinding lid which sets within the grinding compartment when the grinding lid is configured over the grinding compartment.

10. The herb grinder of claim 1, wherein rotary movement of the grinding lid by the user causes the plurality of a sharp edge teeth of the lid to rotate relative to the stationary plurality of sharp edge teeth protruding from the bottom surface of the grinding compartment pulverizes a herb present within the grinding compartment.

11. The herb grinder of claim 1, wherein the side casing is provided to encase the side storage tray within the side casing to collect and store the processed herb.

12. The herb grinder of claim 1, wherein the temporary herb collection chamber further includes a static directional arm attached with the main body and an aperture beside the static directional arm which aligns with an opening of the side storage tray when encased within the side casing of the main body.

13. The herb grinder of claim 1, wherein the rotation of the rotating bottom floor of the temporary herb collection chamber enforces the grinded herb outward from the center while the static directional arm directs the grinded herbs into the aperture from where it enters into the side storage tray.

14. The herb grinder of claim 1, wherein the wire nectar filter is configured to filter out the nectar or crystal present within the grinded herb.

15. A herb grinder with a longitudinal side storage is comprising of:
a main body having a grinding compartment, a temporary collection chamber stacked below the grinding compartment, and a side casing longitudinal to the herb grinding compartment and the temporary collection chamber;
a grinding lid configured over the grinding compartment of the main body having a hand crank at the top surface of the grinding lid;
a central axel passing through a central aperture of the grinding compartment to connect the grinding lid from a top end;
a bottom solid flat plate mounted at the bottom end of the central axel that rotates the bottom solid flat plate with rotation of the grinding lid; and
a side storage tray capable of being insetted into the longitudinal side casing of the main body to collect a processed of grinded herb and store.

16. The herb grinder of claim 15, wherein the grinding compartment includes plurality of a teeth protruding upright from a bottom surface and plurality of holes within the bottom surface of the grinding compartment.

17. The herb grinder of claim 15, wherein the central aperture of the grinding compartment includes a plurality of axel bearings that are configured to allow free rotation of the central axel while keeping the main body stationary.

18. The herb grinder of claim 15, wherein the R-clip locks the solid bottom plate at the bottom end of the central axel.

19. The herb grinder of claim 15, wherein the hand crank of the grinding lid is configured to allow user to hold the hand crank to rotate the grinding lid.

20. The herb grinder of claim 15, wherein the grinding lid further includes a plurality of a sharp edge teeth protruding out of a bottom surface of the grinding lid which sets within the grinding compartment when the grinding lid is configured over the grinding compartment.

21. The herb grinder of claim 15, wherein rotary movement of the grinding lid by the user causes the plurality of a sharp edge teeth of the lid to rotate relative to the stationary plurality of sharp edge teeth protruding from the bottom surface of the grinding compartment pulverizes a herb present within the grinding compartment.

22. The herb grinder of claim 15, wherein the temporary herb collection chamber further includes a static directional arm attached with the main body and an aperture beside the static directional arm which aligns with an opening of the side storage tray when encased within the side casing of the main body.

23. The herb grinder of claim 15, wherein the rotation of the bottom solid flat plate of the temporary herb collection chamber due to the rotation of the grinding lid enforces the grinded herb outward from the center while the static directional arm directs the grinded herbs into the aperture from where it enters into the side storage tray.

24. The herb grinder of claim 15, wherein the herb grinder further includes a side storage lid to magnetically affix at one opening of the side storage tray.

25. The herb grinder of claim 15, wherein the side storage tray detachably attaches with the main body within the side case using a magnets.
